(19) United States
(12) Patent Application Publication
(10) Pub. No.: US 2024/0012607 A1
(43) Pub. Date: Jan. 11, 2024

(54) Wireless Audio Interface System

(71) Applicant: Mark Quall, Alcester, SD (US)

(72) Inventor: Mark Quall, Alcester, SD (US)

(21) Appl. No.: 17/860,583

(22) Filed: Jul. 8, 2022

(51) Int. Cl. G06F 3/16; G06F 3/0488; H04R 3/00

(52) U.S. Cl. CPC G06F 3/162; G06F 3/165; G06F 3/0488; H04R 3/00; H04R 2499/13; H04R 2420/07

(57) ABSTRACT

A wireless audio interface system includes a remote transceiver. A control module is exposed to an interior of the vehicle. An audio communication module is positioned in the vehicle for operational connection to an audio transmitter in the vehicle. The audio communication module is concealed from the driver. Operations of the audio communication module are controllable by manipulation of the control module. The audio communication module includes a base transceiver operationally connectable to the remote transceiver for control of and broadcasting of the audio signal through the audio transmitter using the personal electronic device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle audio devices and more particularly pertains to a new vehicle audio system for modernizing and/or enhancing audio control and broadcast capability within a vehicle.

### (2) Description of Related Art Including Information Disclosed Under 37 CFR 1.97 and 1.98

The prior art relates to vehicle audio devices. Known prior art lacks the capability to control audio production primarily through a personal electronic device with basic control utilizing a control module within a vehicle.

### BRIEF SUMMARY OF THE INVENTION

An embodiment of the disclosure meets the needs presented above by generally comprising a vehicle and a personal electronic device in remote communication with an extrinsic communication network. The personal electronic device includes a remote transceiver. A control module is exposed to an interior of the vehicle. An audio communication module is positioned in the vehicle for operational connection to an audio transmitter in the vehicle. The audio communication module is concealed from the driver. Operations of the audio communication module are controllable by manipulation of the control module. The audio communication module includes a base transceiver operationally connectable to the remote transceiver for control of and broadcasting of the audio signal through the audio transmitter using the personal electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a wireless audio interface assembly according to an embodiment of the disclosure.

FIG. 2 is a perspective view of a control module of an embodiment of the disclosure.

FIG. 3 is a schematic view of an embodiment of the disclosure.

### DETAILED DESCRIPTION OF THE INVENTION

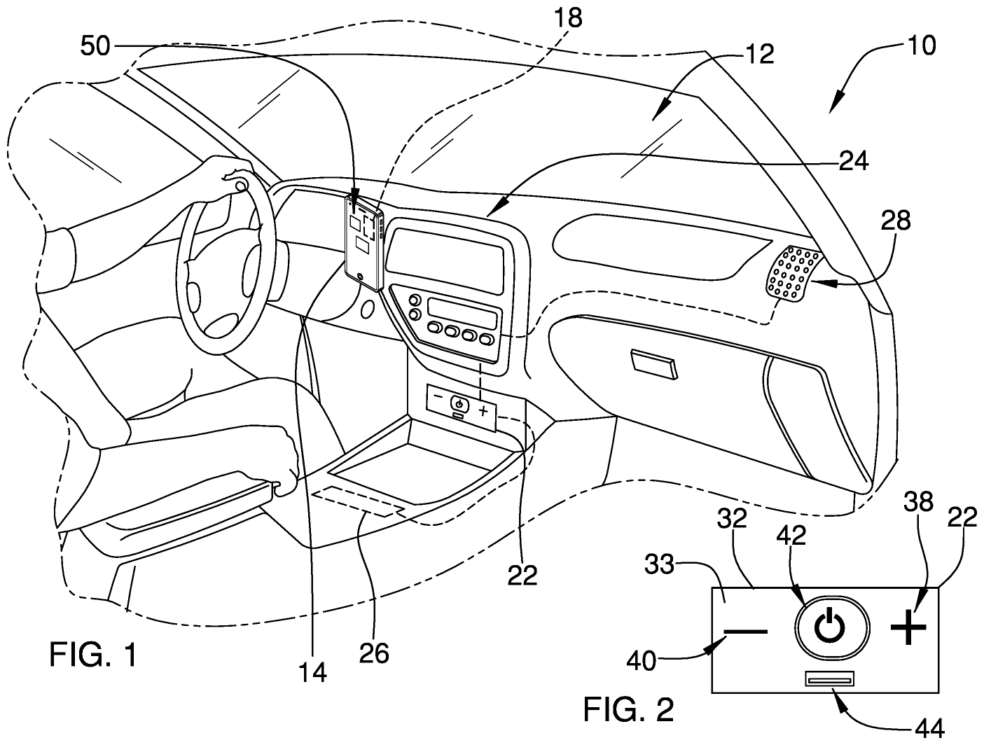

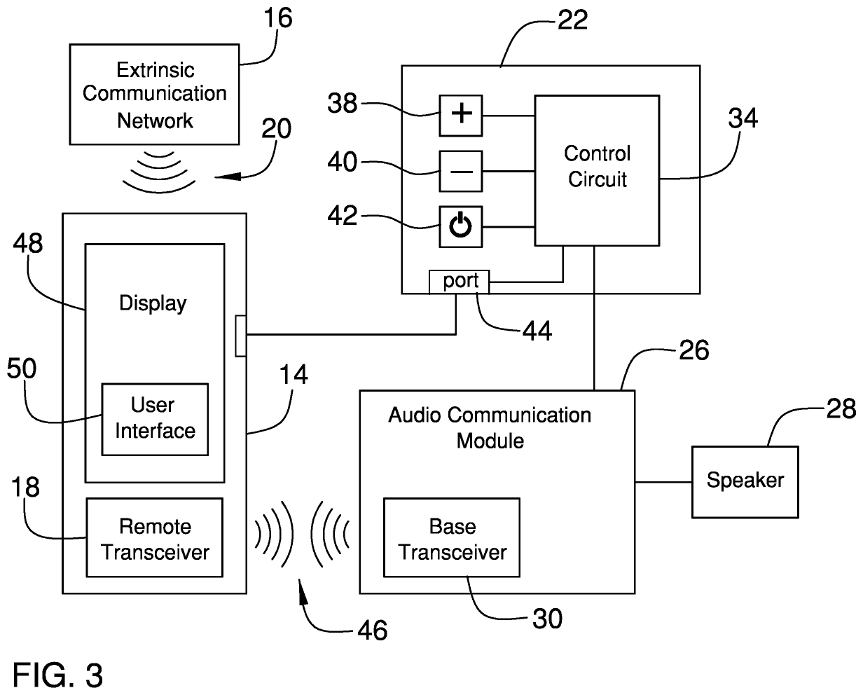

With reference now to the drawings, and in particular to FIGS. 1 through 3 thereof, a new vehicle audio device embodying the principles and concepts of an embodiment of the disclosure and generally designated by the reference numeral 10 will be described.

As best illustrated in FIGS. 1 through 3, the wireless audio interface system 10 generally comprises a vehicle 12 and a personal electronic device 14. The personal electronic device 14 is in remote communication with an extrinsic communication network 16. The personal electronic device 14 includes a remote transceiver 18 wherein an audio signal 20 from the extrinsic communication network 16 is transmissible from the personal electronic device 14. A control module 22 is positionable within the vehicle 12. The control module 22 is exposed to an interior 24 of the vehicle 12 wherein the control module 22 is configured to be accessible to the driver of the vehicle 12 or a passenger within the vehicle 12. An audio communication module 26 is also positioned in the vehicle 12. The audio communication module 26 is configured for operational connection to an audio transmitter 28 in the vehicle 12 such as audio speakers used with a conventional audio setup in a conventional vehicle. The audio communication module 26 is concealed with respect to the interior 24 of the vehicle 12 wherein the audio communication module 26 is configured to be concealed from the driver. The audio communication module 26 is in electrical communication with the control module 22 such that operations of the audio communication module 26 are controllable by manipulation of the control module 22. The audio communication module 26 includes a base transceiver 30 operationally connectable to the remote transceiver 18 thereby facilitating transmission of the audio signal 20 from the personal electronic device 14 to the audio communication module 26 for broadcasting of the audio signal 20 through the audio transmitter 28. Additionally, the remote transceiver 18 may transmit operational signals to be received by the base transceiver 30 for operational control of the audio communication module 26 allowing control of broadcasting of audio through the audio transmitter 28 by manipulation of the personal electronic device 14 using an app or the like.

The control module 22 includes a housing 32 having a front face 33. The front face 33 is exposed to the interior 24 of the vehicle 12. A control circuit 34 is integrated into the housing 32. The control circuit 34 is electrically coupled to the audio communication module 26 and a power source 36. The power source 36 may be an electrical system 38 of the vehicle 12.

The control module 22 further includes a volume up control 38 integrated into the front face 34 of the housing 32 wherein the volume up control 38 is configured to be accessible to the driver. The volume up control 38 is electrically coupled to the control circuit 34 such that the volume up control 38 increases an output volume through the audio transmitter 28 when the volume up control 38 is manipulated. Similarly, a volume down control 40 is integrated into the front face 34 of the housing 32 wherein the volume down control 40 is configured to be accessible to the driver. The volume down control is electrically coupled to the control circuit 34 such that the volume down control 40 decreases an output volume through the audio transmitter 28 when the volume down control 40 is manipulated. A power button 42 is integrated into the front face 34 of the housing 32 wherein the power button 42 is also configured to be accessible to the driver. The power button 42 is electrically coupled to the control circuit 34 such that the power button 42 actuates or de-actuates the audio communication module 26 when the power button 42 is manipulated. Thus, the control module 22 provides alternative control of some basic functions for the audio communication module 26 as an alternative to manipulation of controls through an app on the personal electronic device 14.

A data port 44 is integrated into the front face 34 of the housing 32 of the control module 22 wherein the data port 44 is configured to be accessible to the driver. The data port 44 is electrically coupled to the control circuit 34 wherein the data port 44 is in communication with the audio communication module 26 for transmitting an extrinsic audio signal 46 received through the data port 44 to the audio communication module 26 for broadcast through the audio transmitter 28. The extrinsic audio signal 46 is considered to be any direct signal provided by any device hard wired to the control module 26 through the data port 44. This may include direct connection with the personal electronic device 14 for use of audio signals stored on the personal electronic device 14 or otherwise communicated through the control module 22 other than sourced from the extrinsic communication network 16. The personal electronic device 14 includes a display 48 integrated into the personal electronic device 14. The display 48 displays indicia comprising a graphical user interface 50 derived from data received through the remote transceiver 18 from transmissions from the base transceiver 30 of the audio communication module 26. The display 48 may be a touchscreen display. The graphical user interface displayed may provide operational controls for controlling operations of the audio communication module 26 as described above. The display 48 may further display informational data relating to specific audio broadcasting through the audio transmitter 28.

The data port 44 may also provide hardwired communications between the personal electronic device 14 and the control circuit 34 for setup and initiation of later wireless communications between the remote transceiver 18 and the base transceiver 30.

In use, the wireless audio interface system 10 can provide control of the audio communication module 26 through the display 46 of the personal electronic device 14. The system 10 can replace an existing sound system within any vehicle or provide for modernized audio capabilities within an older vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wireless audio interface system comprising:
a vehicle;
a personal electronic device, said personal electronic device being in remote communication with an extrinsic communication network, said personal electronic device including a remote transceiver wherein an audio signal from the extrinsic communication network is transmissible from said personal electronic device;
a control module being positionable within said vehicle, said control module being exposed to an interior of said vehicle wherein said control module is configured to be accessible to the driver; and
an audio communication module being positioned in said vehicle, said audio communication module being configured for operational connection to an audio transmitter in said vehicle, said audio communication module being concealed with respect to said interior of said vehicle wherein said audio communication module is configured to be concealed from the driver, said audio communication module being in electrical communication with said control module such that operations of said audio communication module are controllable by manipulation of said control module, said audio communication module including a base transceiver operationally connectable to said remote transceiver thereby facilitating transmission of the audio signal from said personal electronic device to said audio communication module for control of and broadcasting of the audio signal through said audio transmitter.

2. The system according to claim 1, wherein said control module comprises:
a housing having a front face, said front face being exposed to said interior of said vehicle; and
a control circuit being integrated into said housing, said control circuit being electrically coupled to said audio communication module and a power source.

3. The system of claim 2, wherein the power source comprises an electrical system of said vehicle.

4. The system according to claim 2, wherein said control module comprises:
a volume up control being integrated into said front face of said housing wherein said volume up control is configured to be accessible to the driver, said volume up control being electrically coupled to said control circuit such that said volume up control increases an output volume through said audio transmitter when said volume up control is manipulated; and
a volume down control being integrated into said front face of said housing wherein said volume down control is configured to be accessible to the driver, said volume down control being electrically coupled to said control circuit such that said volume down control decreases an output volume through said audio transmitter when said volume down control is manipulated.

5. The system of claim 2, wherein said control module further includes a power button being integrated into said front face of said housing wherein said power button is configured to be accessible to the driver, said power button being electrically coupled to said control circuit such that said power button actuates or de-actuates audio communication module when said power button is manipulated.

6. The system of claim 2, further comprising a data port being integrated into said front face of said housing of said control module wherein said data port is configured to be accessible to the driver, said data port being electrically coupled to said control circuit wherein said data port is in communication with said audio communication module for transmitting an extrinsic audio signal received through said data port to said audio communication unit for broadcast through said audio transmitter.

7. The system according to claim 1, wherein said personal electronic device includes a display being integrated into said personal electronic device, said display displaying indicia comprising a graphical user interface derived from data received through said remote transceiver from transmissions from said base receiver of said audio communication module.

8. The system of claim 7, wherein the display is a touchscreen display and the graphical user interface displayed provides operational controls for controlling operations of said audio communication module.

9. A wireless audio interface system comprising:
a vehicle;
a personal electronic device, said personal electronic device being in remote communication with an extrinsic communication network, said personal electronic device including a remote transceiver wherein an audio signal from the extrinsic communication network is transmissible from said personal electronic device;
a control module being positionable within said vehicle, said control module being exposed to an interior of said vehicle wherein said control module is configured to be accessible to the driver;
an audio communication module being positioned in said vehicle, said audio communication module being configured for operational connection to an audio transmitter in said vehicle, said audio communication module being concealed with respect to said interior of said vehicle wherein said audio communication module is configured to be concealed from the driver, said audio communication module being in electrical communication with said control module such that operations of said audio communication module are controllable by manipulation of said control module, said audio communication module including a base transceiver operationally connectable to said remote transceiver thereby facilitating transmission of the audio signal from said personal electronic device to said audio communication module for control of and broadcasting of the audio signal through said audio transmitter;
wherein said control module comprises:
a housing having a front face, said front face being exposed to said interior of said vehicle, and
a control circuit being integrated into said housing, said control circuit being electrically coupled to said audio communication module and a power source, wherein the power source comprises an electrical system of said vehicle;
wherein said control module comprises
a volume up control being integrated into said front face of said housing wherein said volume up control is configured to be accessible to the driver, said volume up control being electrically coupled to said control circuit such that said volume up control increases an output volume through said audio transmitter when said volume up control is manipulated, and
a volume down control being integrated into said front face of said housing wherein said volume down control is configured to be accessible to the driver, said volume down control being electrically coupled to said control circuit such that said volume down control decreases an output volume through said audio transmitter when said volume down control is manipulated;
a power button being integrated into said front face of said housing wherein said power button is configured to be accessible to the driver, said power button being electrically coupled to said control circuit such that said power button actuates or de-actuates audio communication module when said power button is manipulated;
a data port being integrated into said front face of said housing of said control module wherein said data port is configured to be accessible to the driver, said data port being electrically coupled to said control circuit wherein said data port is in communication with said audio communication module for transmitting an extrinsic audio signal received through said data port to said audio communication unit for broadcast through said audio transmitter;
wherein said personal electronic device includes a display being integrated into said personal electronic device, said display displaying indicia comprising a graphical user interface derived from data received through said remote transceiver from transmissions from said base receiver of said audio communication module; and
wherein the display is a touchscreen display and the graphical user interface displayed provides operational controls for controlling operations of said audio communication module.
